(19) United States
(12) Patent Application Publication
(10) Pub. No.: US 2002/0194221 A1
(43) Pub. Date: Dec. 19, 2002

(54) System, method and computer program product for collecting information utilizing an extensible markup language (XML) framework

(76) Inventors: Philip C. Strong, Los Gatos, CA (US); Jason M. Wong, Sunnyvale, CA (US)

Correspondence Address: CARLTON FIELDS, P.O. Box 721030, San Jose, CA, 95172-1030, US

(21) Appl. No.: 09/850,279

(22) Filed: May 7, 2001

(51) Int. Cl. G06F 17/00

(52) U.S. Cl. 707/513; 707/517

(57) ABSTRACT

A system, method and computer program product for collecting information are disclosed. In general, information is displayed to a user. The displayed information is based on at least a portion of a plurality of record element constructors of a template. Input for the record element constructors is then received from the user in response to the displayed information. A determination is then made as to whether the received input is valid for the record element constructors. The record elements are subsequently generated based on the record element constructors and the received input. The record elements are then stored in a database.

### FIELD OF THE INVENTION

This invention relates to data collection, and more particularly, relates to data collection utilizing an extensible markup language (XML).

### BACKGROUND OF THE INVENTION

The pharmaceutical industry is in the early stages of a rapid and dramatic transformation. A variety of changes in the political, technological and competitive landscapes provide both threat and opportunity for these companies. The battle for market share is intensifying among multiple products competing on efficacy, side effect profile, cost and patient quality of life. Payers, both public and private are placing an increased emphasis on proven cost-effectiveness. Patients are demanding therapies that maintain quality of life while controlling their disease just as regulators are demanding more intense scrutiny of potentially harmful pharmacological side effects.

The result of these changes is a critical need for data and new data collection methods. From the earliest stage of human testing and throughout the useful life of an approved drug product, companies now find their drug development and sales efforts caught behind this data bottleneck. Meanwhile, hospitals, insurers, health maintenance organizations (HMO's), and various government payers are also in search of data that justifies the high cost of modem medicines. Complicating this growing need for pharmacological data is a mounting concern for patient privacy. New Health Insurance Portability and Accountability Act (HIPAA) regulations regarding privacy, with potential civil and criminal penalties, appear threatening to the drug companies and to the healthcare industry in general. These challenges demand new ongoing methods for efficiently accessing and collecting drug outcomes data.

### SUMMARY OF THE INVENTION

A system, method and computer program product for collecting information are disclosed. In general, information is displayed to a user. The displayed information is based on at least a portion of a plurality of record element constructors of a template. Input for the record element constructors is then received from the user in response to the displayed information. A determination is then made as to whether the received input is valid for the record element constructors. The record elements are subsequently generated based on the record element constructors and the received input. The record elements are then stored in a database.

In an aspect of the present invention, the template may be in an extensible markup language (XML) format. In another aspect of the present invention, one or more extensible style sheet language (XSL) style sheets may be utilized during execution of the process. In a further aspect of the present invention, the template may be divided into a plurality of sections each having a plurality of record element constructors. In such an aspect, the disclosed process may be repeated for each section of the template.

In one aspect of the present invention, an extensible style sheet language (XSL) style sheet may be applied to at least a portion of the record element constructors to generate the information displayed to the user. In an additional aspect of the present invention, the record elements may be utilized in providing health care to the user. In even another aspect of the present invention, an alert may be displayed to the user if any of the input is determined to be invalid for the record element constructors. In such an aspect, the user may be required to provide additional input unit for the portion of the input determined to be invalid.

In yet one more aspect of the present invention, the information may be displayed to the user in an hypertext markup language (HTML) format. In another aspect of the present invention, the information may be displayed to the user utilizing a network. In a further aspect of the present invention, the stored record elements may be retrieved by and displayed to at least one of the user and a third party. In an additional aspect of the present invention, a request for a service associated with the user may be received. Stored record elements associated with the user may then be retrieved from the database so that an order may be issued based on the request and the retrieved record elements.

### BRIEF DESCRIPTION OF THE DRAWINGS

FIG. 1 is a schematic representation of an illustrative worksheet management framework utilizing extensible markup language (XML) worksheet templates in accordance with an embodiment of the present invention;

FIG. 2 is a schematic diagram of an XML worksheet framework for health care providers in accordance with an embodiment of the present invention;

FIG. 3 is a schematic diagram of an XML infrastructure for supporting an XML worksheet framework in accordance with an embodiment of the present invention;

FIG. 4 is a flowchart of a process for generating a worksheet in an extensible XML worksheet framework in accordance with an embodiment of the present invention;

FIG. 5 is a schematic diagram illustrating the generation of a display from a worksheet template in accordance with an exemplary embodiment of the present invention;

FIG. 6 is a schematic diagram illustrating an alert displayed to a user in accordance with an exemplary embodiment of the present invention;

FIG. 7 is a schematic diagram illustrating the accumulation of record elements in accordance with an exemplary embodiment of the present invention;

FIG. 8 is a schematic diagram illustrating the generation of transition logic XML in accordance with an exemplary embodiment of the present invention;

FIG. 9 is a schematic diagram illustrating the generation of a subsequent display from a worksheet template in accordance with an exemplary embodiment of the present invention;

FIG. 10 is a schematic diagram illustrating a completed XML worksheet record in accordance with an exemplary embodiment of the present invention;

FIG. 11 is a flowchart of a process for collecting information in accordance with an embodiment of the present invention;

FIG. 12 is a schematic diagram of an illustrative system with a plurality of components in accordance with an embodiment of the present invention; and

FIG. 13 is a schematic diagram of a representative hardware environment in accordance with an embodiment of the present invention.

### DETAILED DESCRIPTION

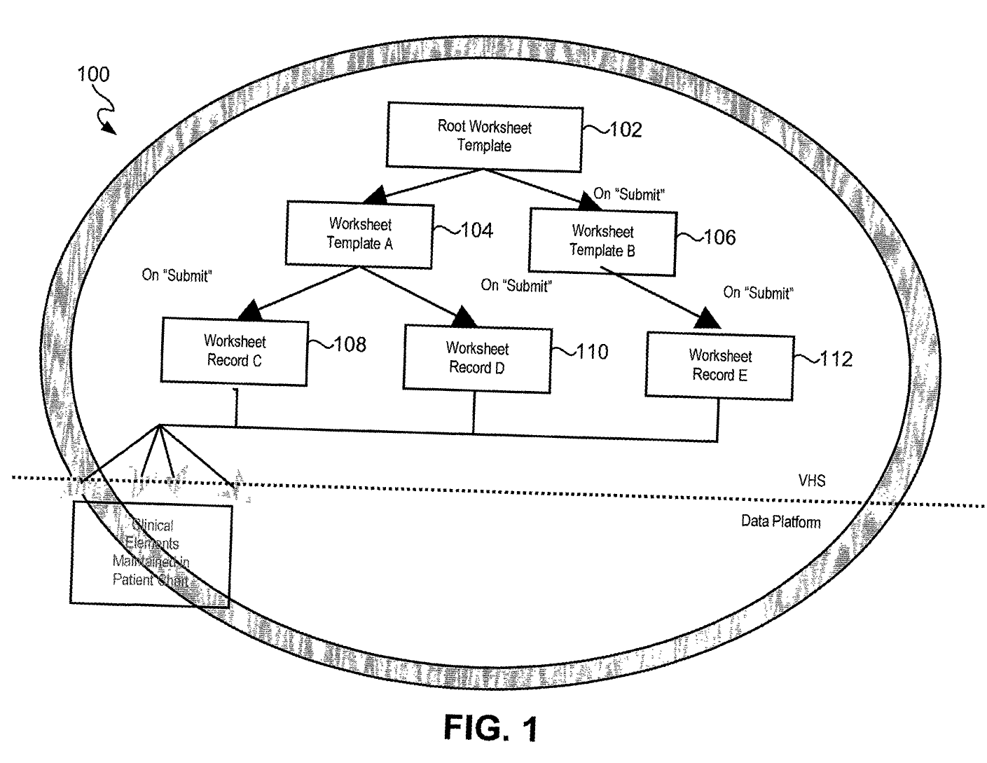

FIG. 1 is a schematic representation of an illustrative worksheet management framework 100 illustrating various illustrative paths for generating a worksheet utilizing XML worksheet templates in accordance with an embodiment of the present invention. Worksheets take their name from the various income tax worksheets that the Internal Revenue Service (IRS) supplies to help taxpayers complete their tax returns. Each worksheet computes intermediate data used by taxpayers in the overall process of completing their tax returns. In a similar way, worksheets of the present invention may be utilized to help contribute clinical elements from specific care management activities to the overall process of care.

The XML worksheet framework may be built on open Internet standards using technologies that include XML, Java, WAP, and Security protocols. The framework may be utilized to create an HL-7 version 3 compatible abstraction layer on top of existing databases and applications. The abstraction layer allows building server-based smart applications that greatly simplify operations. In addition to fast deployment, the framework allows quick adaptation, as user needs change. The framework may also be scaled up to large numbers of users and support high volumes of concurrent transactions.

In accordance with a preferred embodiment of the present invention, extensible markup language (XML) worksheets may be utilized to allow users to: 1) create sets of clinical constructs useful for disease management programs and other health care processes, 2) choose elements of these sets based on evaluation criteria inherent in the worksheet, 3) document the elements chosen and the rationale for their selection at every stage in the use of the worksheet. By using worksheets, case managers may efficiently oversee large number of enrolled participants, without regard to geography, while maintaining the highest standards of evidence-based care.

In one embodiment of the present invention, a worksheet record may simply be collections of clinical elements. A worksheet template may comprise partially formulated clinical elements and evaluation criteria for helping to determine the final worksheet record that results once the template is completed. This is illustrated in FIG. 1. Each worksheet template (e.g., root worksheet template 102) presents choices to the user as a navigation path for evaluation criteria that lead to the next worksheet template (e.g., worksheet template A 104 or worksheet template B 106) or produces a worksheet record (e.g., worksheet record C 108, worksheet record D 110 or worksheet record E 112). The worksheet management program 100 thus comprises the entire collection of subordinate worksheets as they are presented to users over time. In the preferred health care embodiment of the present invention, the worksheet management program may be referred to as a disease management program.

In accordance with an embodiment of the present invention, for users (e.g., patients) enrolled in more than one disease management program, a process of program harmonization may be required to help resolve conflicting recommendations and help ensure that the logistics of satisfying sets of clinical elements is tractable.

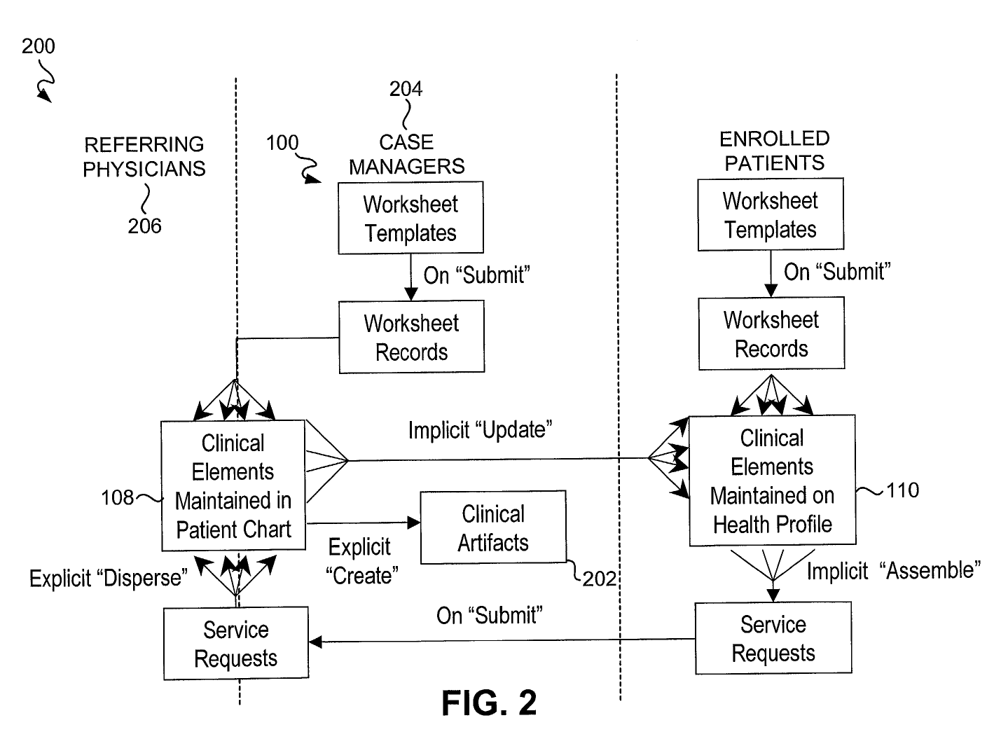

FIG. 2 is a schematic diagram of a worksheet framework 200 for health care providers in accordance with an embodiment of the present invention. In this framework, worksheets 100 operate against an XML infrastructure that provides the ability to contribute a variety of artifacts 202 to a care process, such as, for example: prescriptions, test requisitions, referral-authorization requests, appointment scheduling, problem lists, reminders, etc. These are available to disease management program users 204 as well as to referring physicians and their staffs 206.

The XML infrastructure may also functions as an application programming interface (API) between disease management programs and a wide variety of other underlying platforms 208, 210 such as electronic medical records, practice management systems, hospital and other legacy medical information systems, etc.

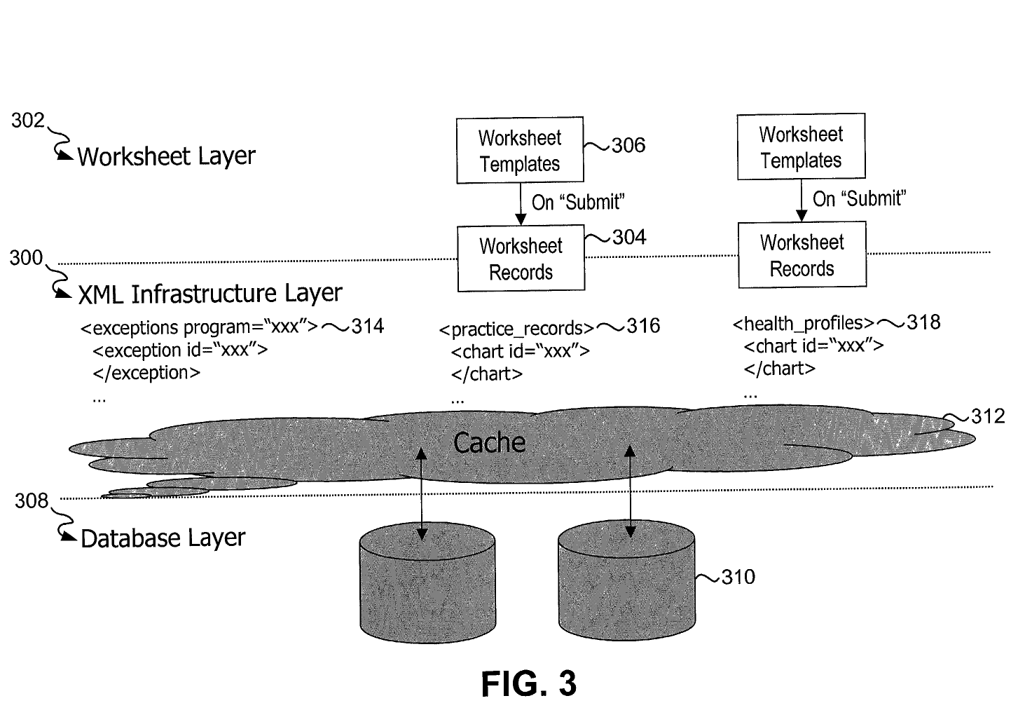

FIG. 3 is a schematic diagram of an XML infrastructure 300 for supporting an XML worksheet framework in accordance with an embodiment of the present invention. The XML infrastructure 300 provides an interface between a worksheet layer 302 where worksheet records 304 are created utilizing worksheet templates 306 and a database layer 308 where data (including worksheet records) may be stored in databases 310.

The XML infrastructure 300 may provide a common, standards-based platform for applications of the worksheet framework so that once the XML infrastructure is implemented for one worksheet application, it may be utilized to support any or all other worksheet applications of the present invention. By utilizing XML, the infrastructure may also be compatible with HL7 RIM. The XML infrastructure 300 also helps to provide server platform independence by being implemented on web-servers on top of a user's underlying IT infrastructure and also presents very simple interface (write-through cache 312) to underlying infrastructure. The XML infrastructure 300 may further help to provide client platform independence where a final style sheet transformation for each worksheet may produce HTML or WAP output which is compatible with a variety of devices.

In one embodiment, the XML infrastructure layer 300 may reside in an Application Object on one or more web-servers. In another embodiment, the worksheet layer 302 may operate against the XML infrastructure cache 312. As an option, XML infrastructure components may also be parsed (i.e., stored as “DOM” constructs) in the Application Object for higher performance. Components of the XML infrastructure layer 300 may include infrastructure constructs and worksheet constructs. Infrastructure constructs are practice-specific DOM-constructs and may include an exception table 314, practice records 316, and health profiles 318. Worksheet constructs are also practice-specific DOM-constructs and may include XML worksheets and associated XSL-T worksheet style sheets. Worksheet constructs may be stored and maintained in one place. However access to them may be to be “practice-specific”, according to the programs a particular practice implements. In a preferred embodiment, all worksheets may operate exclusively against the XML infrastructure cache 312. Focusing on the exception table 314, exceptions may be logged in the underlying IT infrastructure for the practice. Once logged, these exceptions may also be stored in the exception table(s) of all associated web-servers. The exception table may be actively updated across all web-servers accessible to a given practice. In one aspect, every web-server for the practice may see the same version of its exception table(s). Additionally, record locking may occur and is recorded on the exception table when a user “clicks-through” it to access underlying practice record data (e.g. a patient chart). This property of exception tables allows multiple case managers to see what records are already being processed so they can operate on other records while also preventing multiple case managers from simultaneously accessing the same patient chart. With respect to practice records 316, clinical elements may be considered the “atoms” of the cache 312. In a preferred embodiment, only the program-specific subset of clinical elements from a patient chart may be brought into the cache so that the full record is not needed. In use, practice record components may get into the cache 312 either on a user click-through from the exception table or on a user click-through from a chart search, otherwise, the cache behaves as a “write-through” cache. Health profile records 318 have a parallel structure to practice records 316 in that clinical elements are the “atoms” of the cache and only the program-specific subset of clinical elements from a health profile may be brought into the cache. Health profile components may get into the cache on user log-in, otherwise the cache behaves as a “write-through” cache.

In accordance with one aspect of the present invention, the XML infrastructure may be segmented by users into practices with each user allowed to have their own program selection. For example, one user may implement only diabetes programs utilizing the worksheet framework, while another user may implement both the diabetes programs as wells as anti-coagulant programs with the XML infrastructure. Additionally, the XML infrastructure may be segmented by program parameters. For example, User A's anti-coag warfarin dosing algorithm utilized in the worksheet framework can be different from User B's dosing algorithm. Further, one or more practices may be segment per web-server thereby facilitating common implementation using an ASP business model. Also, practice data may be spread across multiple web-servers for improved performance.

In general, a worksheet template comprises a plurality of sections each comprising a plurality of record element constructors. An algorithm “walks” the worksheet template XML, controlling browser display section-by-section, by sequentially applying various Extensible Style sheet Language Transformations (XSLT) style sheets. In so doing, record element constructors are ultimately transformed into record elements. The entire set of derived record elements comprises the “worksheet record”, which may then be written to a database as a transaction.

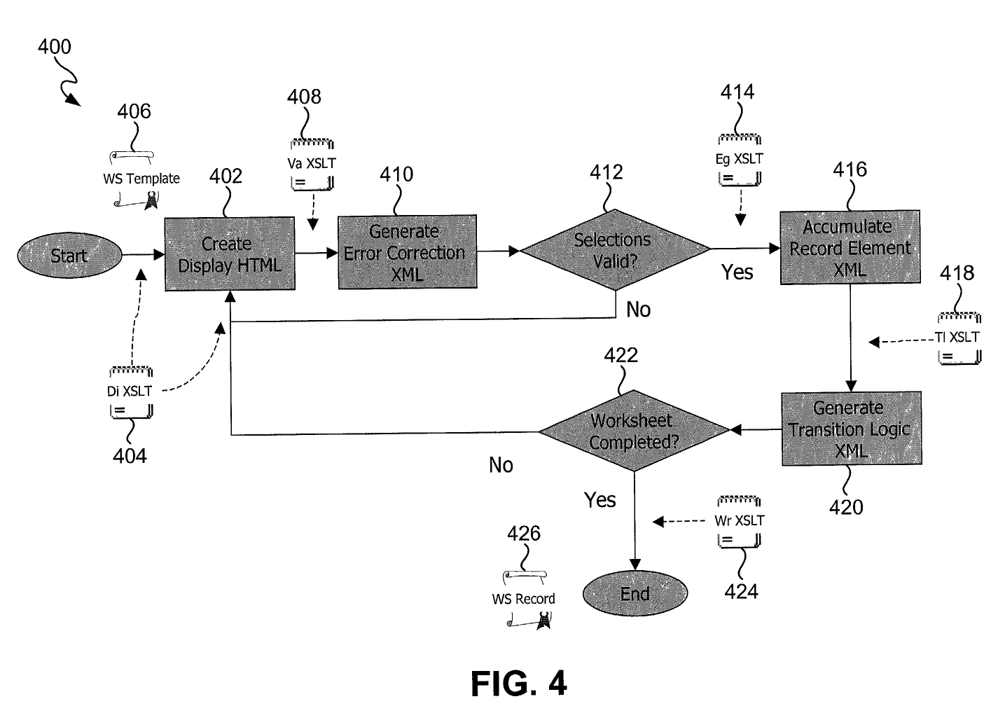

In closer detail, FIG. 4 is a flowchart of a process 400 for generating a worksheet in an extensible markup language (XML) worksheet framework in accordance with an embodiment of the present invention. In operation 402, a Display XSLT (Di XSLT) style sheet 404 is applied to an XML section of an XML worksheet template 406 to create a display HTML which is displayed to a user. It should be noted for further clarification that the DiXSLT 404 is applied to the entire XML template 406 but displays only the section of the XML template that is specified by parameters passed to the DiXSLT 404 (as is the case each time a style sheet (e.g., the Di XSLT 404, the Va XSLT 408, the Eg XSLT 414, the T1 XSLT 418, and the Wr XSLT 424) is applied to the template 406 in the process 400). Input/selections is/are received from the user in response to the displayed HTML and a Validation XSLT (Va XSLT) style sheet 408 is applied the XML section and received input to generate error correction XML in operation 410 so that a determination may be made as to whether the received input/selection by the user is valid for the particular portion of the XML section of the worksheet template in operation 412. If any of the input is determined to be invalid, then the process is returned to operation 402.

On the other hand, if the input is determined to be valid, then a Element Generation XSLT (Eg XSLT) style sheet 414 is applied to the XML section and validated input to accumulate record element XML's in operation 416. A Transition-Logic XSLT (T1 XSLT) style sheet 418 is then applied to the worksheet template 406 (now modified) to generate transition logic XML in operation 420. In operation 422, a determination is then made as to whether the worksheet has been completed by the user. If it is determined that the worksheet is not completed then a Di XSLT style sheet is applied to the next XML section of the worksheet template 406. If it is determined that the worksheet has been completed in operation 422, then a Worksheet Record XSLT (Wr XSLT) style sheet 424 is applied to generate a completed Worksheet Record 426.

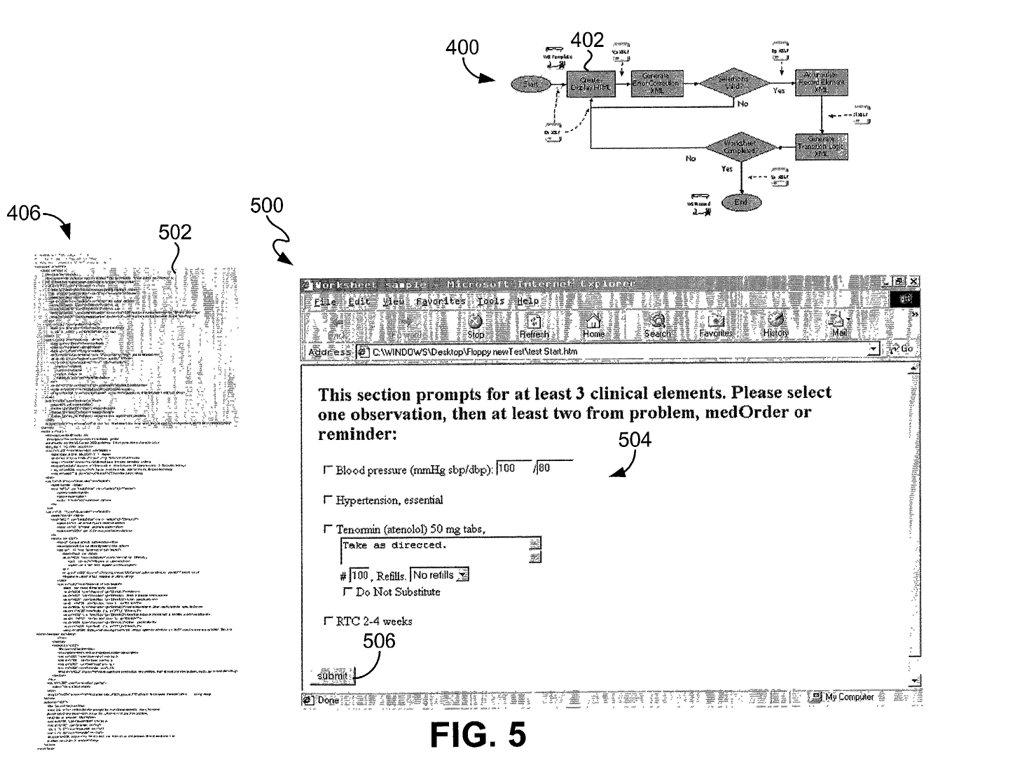

FIGS. 5 through 10 each illustrate various operations of the process 400 set forth in FIG. 4 for an exemplary embodiment of the present invention. In the upper right-hand corner each of these Figures, is the flowchart of the process 400 set forth in FIG. 4 with the operations being executed in the particular figure highlighted. Depicted on the left side of each of these Figures is the XML code of an exemplary XML worksheet template 406 with the particular XML code being accessed and/or used during the particular operation(s) of the process 400 highlighted.

FIG. 5 is a schematic diagram illustrating the generation of a display 500 from a worksheet template in the process 400 for generating a worksheet set forth in FIG. 4 in accordance with an exemplary embodiment of the present invention. As highlighted in FIG. 5, operation 402 is being executed and a first section 502 of the worksheet template 406 is being utilized (The exemplary XML code for the XML worksheet template 406 as shown in FIG. 5 is set forth below in Appendix A). In this exemplary embodiment of the present invention, application of the Di XSLT style sheet 404 to this section of the worksheet template 406 results in a display 500 which prompts a user to input responses for queries generated from record element constructors of the section 502 of the worksheet template 406. In this exemplary embodiment, the generated display 500 displays several queries 504 and prompts the user to input at least three clinical elements and includes input fields, radio buttons and pull down menus for the user to input responses to the displayed queries. A submit button 506 may also be displayed for submitting the various user responses to the system upon selection thereof by the user.

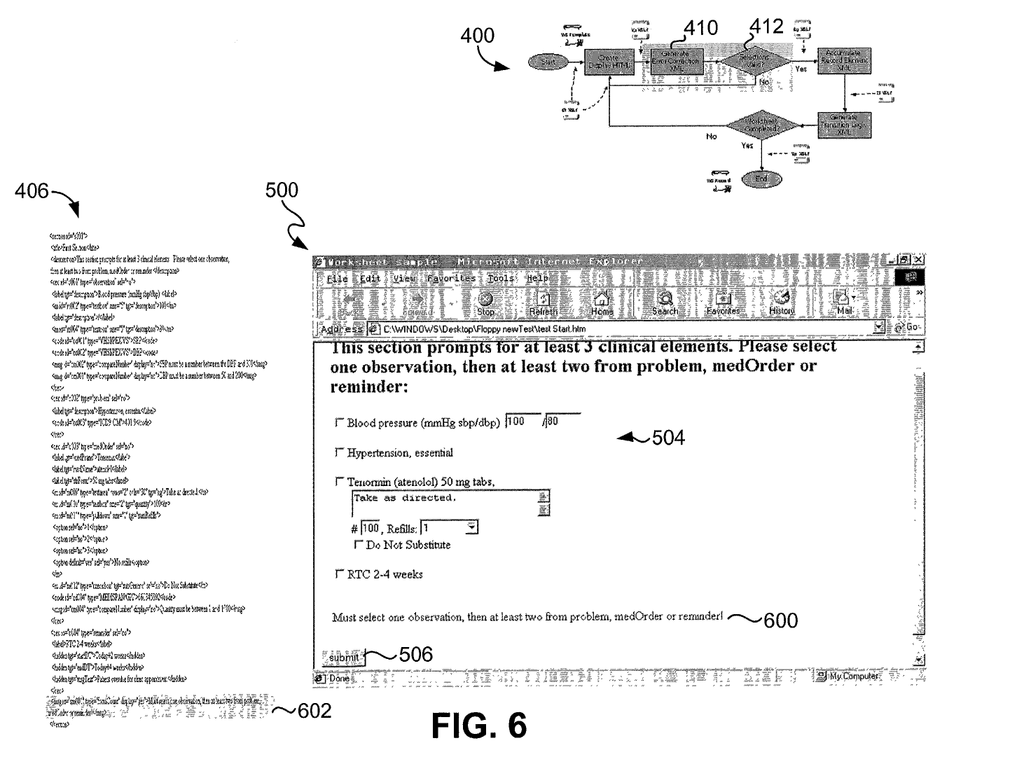

FIG. 6 is a schematic diagram illustrating an alert 600 generated and displayed to the user when at least one submitted user input is determined to be invalid in the process 400 for generating a worksheet in accordance with an exemplary embodiment of the present invention. FIG. 6 illustrates a scenario where at least a portion of the user input is determined to be invalid during execution of operations 410 and 412 (the XML code 602 of the worksheet template relating to the alert is also highlighted in FIG. 6). In accordance with the flowchart of process 400, the display 500 displayed to the user in operation 402 is re-displayed to the user with the generated alert 600 informing the user that at least one of the user's inputted responses to the displayed queries was determined to be invalid. In one embodiment, the alert 600 may be highlighted (e.g., colored a different color than the rest of the display 500) for aiding the user recognition of the alert. The alert may also include the generation of an audible sound which is played to the user upon the re-display of the display 500.

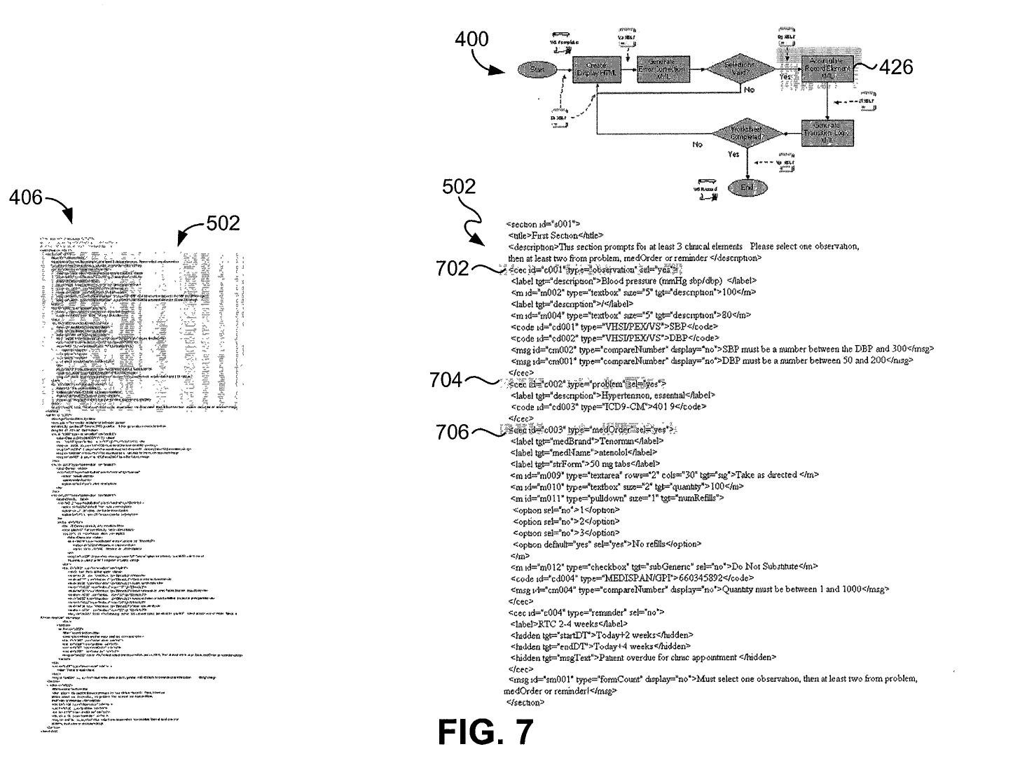

FIG. 7 is a schematic diagram illustrating the accumulation of record elements per operation 416 in the process 400 for generating a worksheet set forth in FIG. 4 in accordance with an exemplary embodiment of the present invention. In FIG. 7, accumulated record element XML's 702, 704, 706 of the section 502 of the worksheet 406 are highlighted.

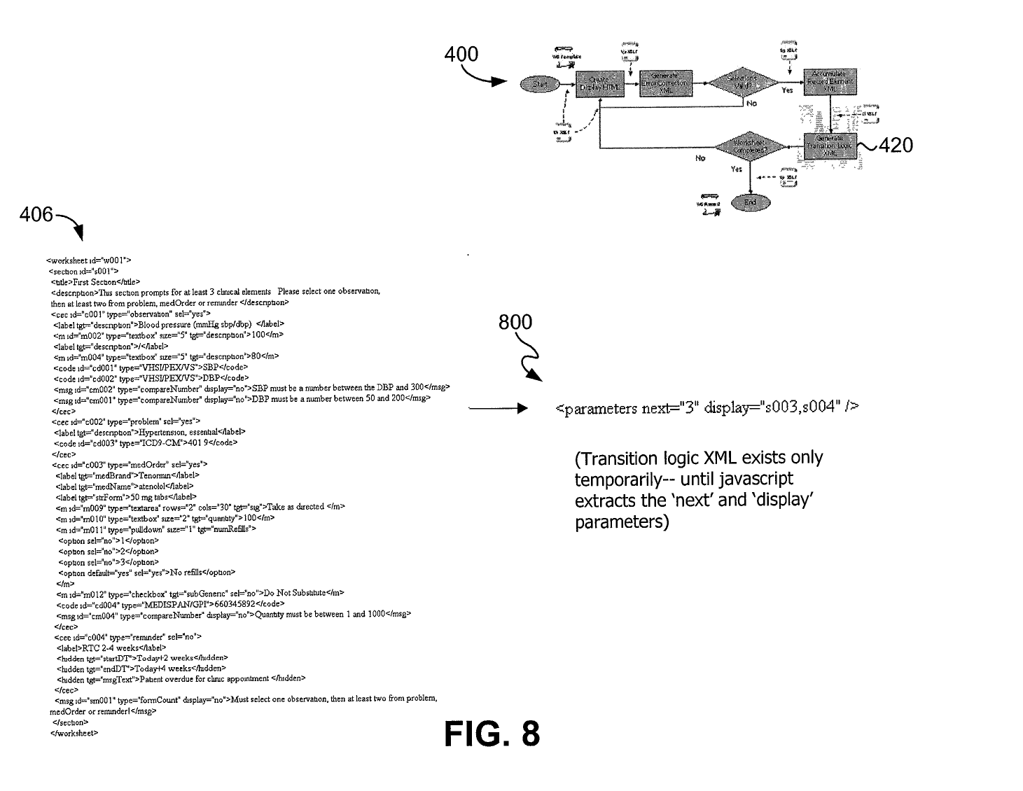

FIG. 8 is a schematic diagram illustrating the generation of transition logic XML 800 during the execution of operation 420 of the process 400 for generating a worksheet set forth in FIG. 4 in accordance with an exemplary embodiment of the present invention. As noted in FIG. 8, transition logic XML 800 exists only temporality until JavaScript extracts the ‘next” and ‘display’ parameters from the transition logic XML 800.

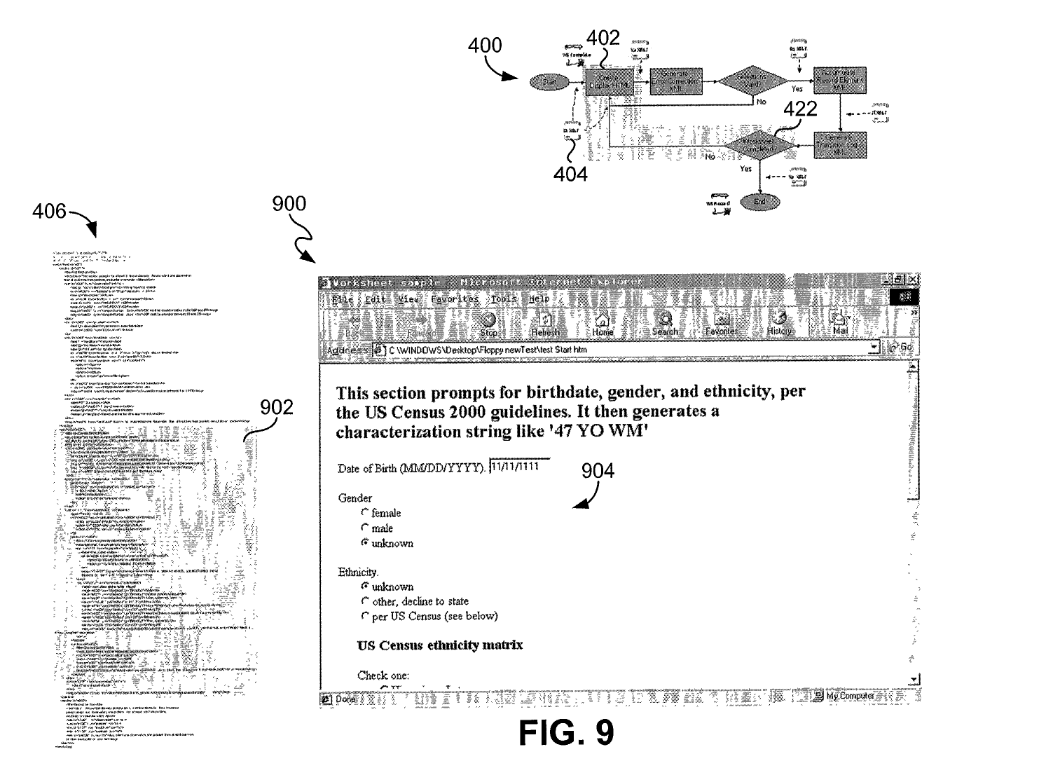

FIG. 9 is a schematic diagram illustrating the generation of a subsequent display 900 from the worksheet template in the process 400 for generating a worksheet set forth in FIG. 4 in accordance with an exemplary embodiment of the present invention. In the present exemplary embodiment, in operation 422, it is determined that the worksheet template 406 has not been completed. As a result, the Di XSLT style sheet 404 is applied to a second XML section 902 of the worksheet template 406 in operation 402 to generate and display the subsequent display 900 to the user. As illustrated in FIG. 9, in this subsequent exemplary display 900, queries 904 are displayed prompting the user to provide information relating to birth date, gender and ethnicity.

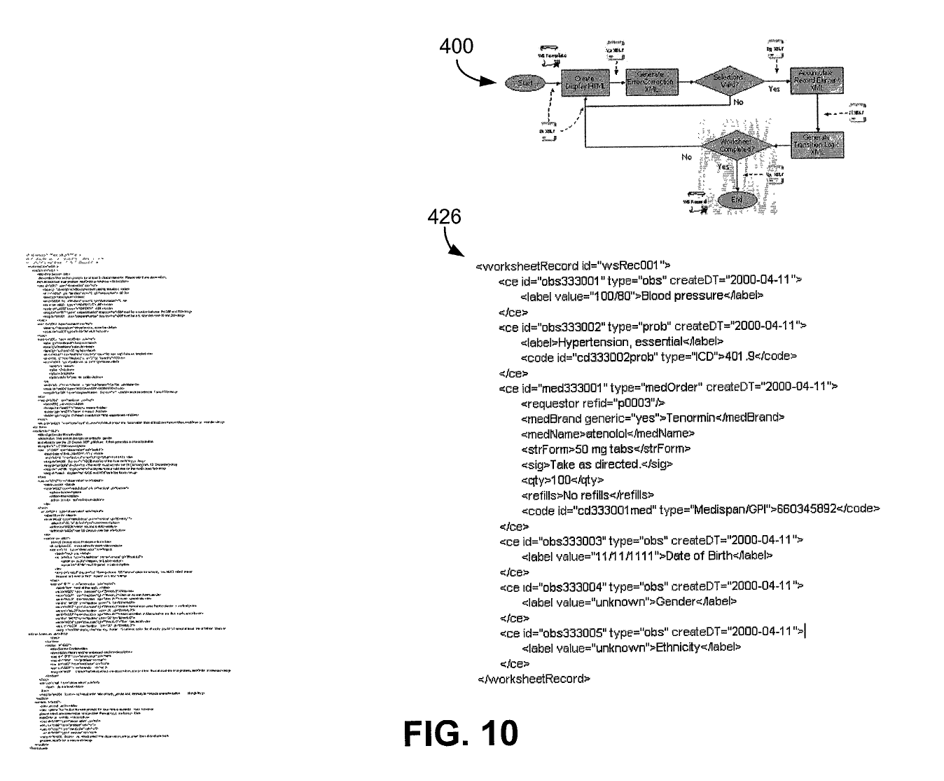

FIG. 10 is a schematic diagram illustrating a completed XML worksheet record 426 generated by the process 400 set forth in FIG. 4 (see operation 422) in accordance with an exemplary embodiment of the present invention.

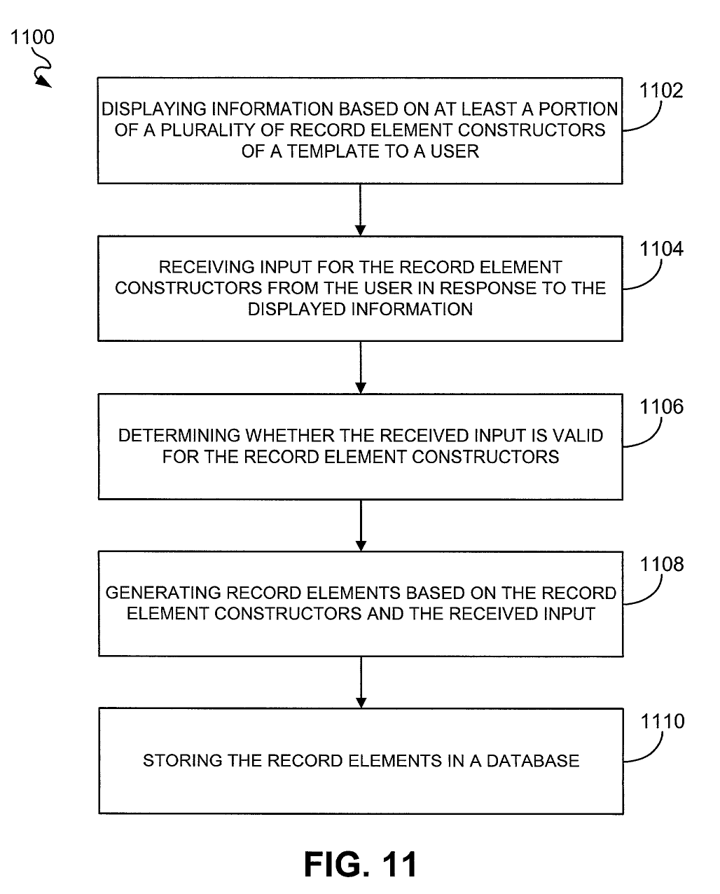

FIG. 11 is a flowchart of a process 1100 for collecting information in accordance with an embodiment of the present invention. In operation 1102, information is displayed to a user. The displayed information is based on at least a portion of a plurality of record element constructors of a template. Input for the record element constructors is then received from the user in response to the displayed information in operation 1104. A determination is then made in operation 1106 as to whether the received input is valid for the record element constructors. The record elements are subsequently generated based on the record element constructors and the received input in operation 1108. The record elements are then stored in a database as a transaction in operation 1110.

In one embodiment, the template may be written in an XML format. In another embodiment, a set of one or more extensible style sheet language (XSL) style sheets may be utilized during execution of the process. In a further embodiment, the template may be divided into a plurality of sections each having a plurality of record element constructors. In such an embodiment, the disclosed process may be repeated for each section of the template prior to storing of the record elements into the database.

In another embodiment, an extensible style sheet language (XSL) style sheet may be applied to at least a portion of the record element constructors to generate the information displayed to the user. In an additional embodiment, the record elements may be utilized in providing health care to the user. In even another embodiment, an alert/notice may be displayed to the user along with a re-display of the information based on the record element constructors if any of the input is determined to be invalid for the record element constructors. In such an embodiment, the user may be required to provide additional input unit for the portion of the input determined to be invalid.

In yet one more embodiment of the present invention, the information may be displayed to the user in an hypertext markup language (HTML) format. However, it should be understood that the information may be displayed to a user in any format (not just HTML) that is compatible with XSLT. An example of an alternate format for displaying to the user is Portable Document Format (PDF) or Wireless Markup Language (WML)

In another embodiment, the information may be displayed to the user utilizing a network such as a local area network, wide area network or the Internet capable of communicating utilizing a Transmission Control Protocol/Internet Protocol (TCP/IP) or Internetwork Packet Exchange (IPX) protocol. In a further embodiment, the stored record elements may be retrieved by and displayed to at least one of the user and a third party. In an additional embodiment, a request for a service associated with the user may be received. Stored record elements associated with the user may then be retrieved from the database so that an order for executing an artifact may be issued based on the request and the retrieved record elements.

Extensible Markup Language (XML) is a flexible way to create common information formats and share both the format and the data on the World Wide Web, intranets, and elsewhere. For example, computer makers might agree on a standard or common way to describe the information about a computer product (processor speed, memory size, and so forth) and then describe the product information format with XML. Such a standard way of describing data would enable a user to send an intelligent agent (a program) to each computer maker's Web site, gather data, and then make a valid comparison. XML can be used by any individual or group of individuals or companies that wants to share information in a consistent way.

XML is similar to Hypertext Markup Language (HTML). Both XML and HTML contain markup symbols to describe the contents of a page or file. HTML, however, describes the content of a Web page (mainly text and graphic images) only in terms of how it is to be displayed and interacted with. For example, the letter “p” placed within markup tags starts a new paragraph. In contrast, XML describes the content in terms of what data is being described. For example, the word “phonenum” placed within markup tags could indicate that the data that followed was a phone number. This means that an XML file can be processed purely as data by a program or it can be stored with similar data on another computer or, like an HTML file, that it can be displayed. For example, depending on how the application in the receiving computer wanted to handle the phone number, it could be stored, displayed, or dialed.

XML is “extensible” because, unlike HTML, the markup symbols are unlimited and self-defining. XML is actually a subset of the Standard Generalized Markup Language (SGML), the standard for how to create a document structure. XML markup may appear within an HTML page.

Extensible Style sheet Language (XSL), formerly called Extensible Style Language, is a language for creating a style sheet that describes how data sent over the Web using XML is to be presented to the user. For example, in an XML page that describes the characteristics of one or more automobiles for an insurance company, a set of open and close <automfg> tags might contain the name of an auto manufacturer. Using XSL, you could tell the Web browser that the auto manufacturer name should be displayed, where to display it on a page, and that it should be displayed in a bold font. XSL is based on and extends the Document Style Semantics and Specification Language (DSSSL) and the Cascading Style Sheet, level 1 (CSS1) standards.

XSL gives a developer the tools to describe exactly which data fields in an XML file to display and exactly where and how to display them. Like any style sheet language, XSL can be used to create a style definition for one XML document or reused for many other XML documents. XSL is a language for expressing style sheets. It comprises two parts: (1) a language for transforming XML documents; and (2) an XML vocabulary for specifying formatting semantics. An XSL style sheet specifies the presentation of a class of XML documents by describing how an instance of the class is transformed into an XML document that uses the formatting vocabulary.

XSL Transformations (XSLT) is a standard way to describe how to transform the structure of an XML document into an XML document with a different structure. XSLT may be thought of as an extension or part of XSL. XSLT shows how the XML document should be reorganized into another data structure (which could then be presented by following an XSL). XSLT may be used to describe how to transform the source tree or data structure of an XML document into the result tree for a new XML document, which can be completely different in structure. More generally, XSLT may be applied to any document which has a valid tree structure, which includes XML, HTML, etc., and can transform this tree into another tree or into a text-based format (like RTF, PDF, etc.). The coding for the XSLT may be referred to as a style sheet and can be combined with an XSL style sheet or be used independently.

A style sheet is a definition of a document's appearance in terms of such elements as: (1) the default typeface, size, and color for headings and body text; (2) how front matter (preface, figure list, title page, and so forth) should look; (3) how all or individual sections should be laid out in terms of space (for example, two newspaper columns, one column with headings having hanging heads, and so forth); (4) line spacing, margin widths on all sides, spacing between headings, and so forth; (5) how many heading levels should be included in any automatically generated Table of Contents; and (6) any boilerplate content that is to be included on certain pages (for example, copyright statements).

Typically, a style sheet may be specified at the beginning of an electronic document, either by embedding it or linking to it. This style sheet applies to the entire document. As necessary, specific elements of the overall style sheet can be overridden by special coding that applies to a given section of the document. For Web pages, a style sheet performs a similar function, allowing the designer to ensure an underlying consistency across a site's pages. The style elements can be specified once for the entire document by either imbedding the style rules in the document heading or cross-referring (linking to or importing) a separate style sheet. A browser may allow the user to override some or all of the style sheet attributes. A cascading style sheet is a style sheet that anticipates that other style sheets will either fill in or override the overall style sheet. This provides the designer the advantage of being able to rely on the basic style sheet when desired and overriding it when desired. The filling in or overriding can occur on a succession of “cascading” levels of style sheets. For example, one style sheet could be created and linked to from every Web page of a Web site as the overall style sheet. For any portion of a page that included a certain kind of content such as a catalog of products, another style sheet that amends the basic style sheet could be linked to. Within the span of that style sheet, yet another style sheet could be specified as applying to a particular type of product display.

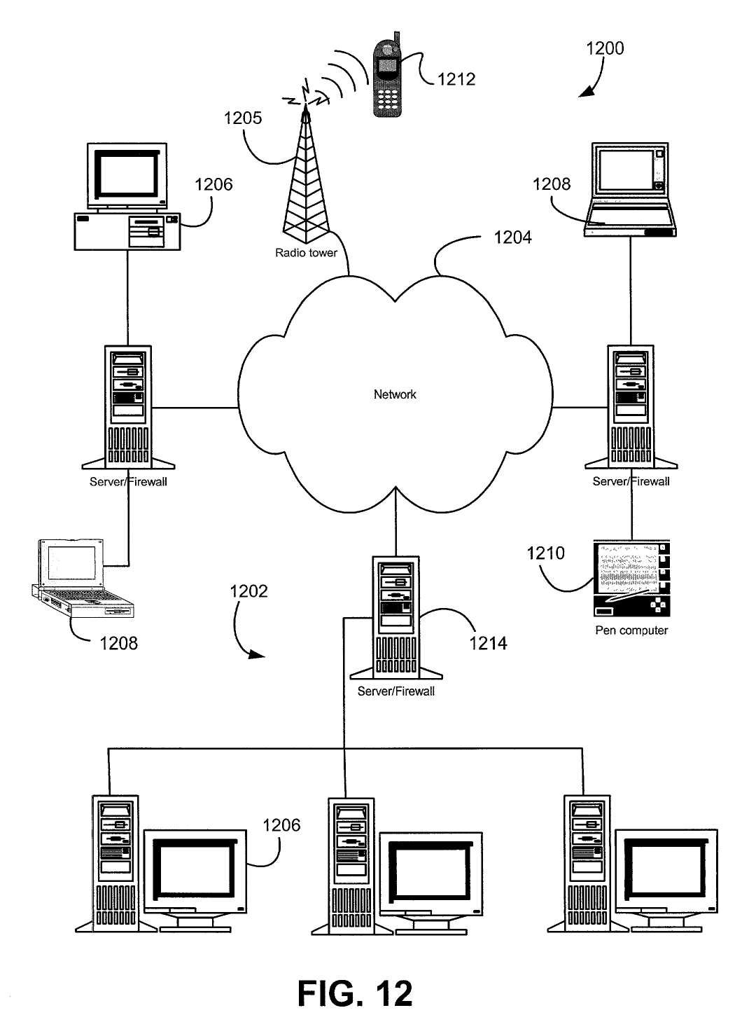

FIG. 12 illustrates an exemplary system 1200 with a plurality of components 1202 in accordance with one embodiment of the present invention. As shown, such components include a network 1204 which take any form including, but not limited to a local area network, a wide area network such as the Internet, and a wireless network 1205. Coupled to the network 1204 is a plurality of computers which may take the form of desktop computers 1206, lap-top computers 1208, hand-held computers 1210 (including wireless devices 1212 such as wireless PDA's or mobile phones), or any other type of computing hardware/software. As an option, the various computers may be connected to the network 1204 by way of a server 1214 which may be equipped with a firewall for security purposes. It should be noted that any other type of hardware or software may be included in the system and be considered a component thereof.

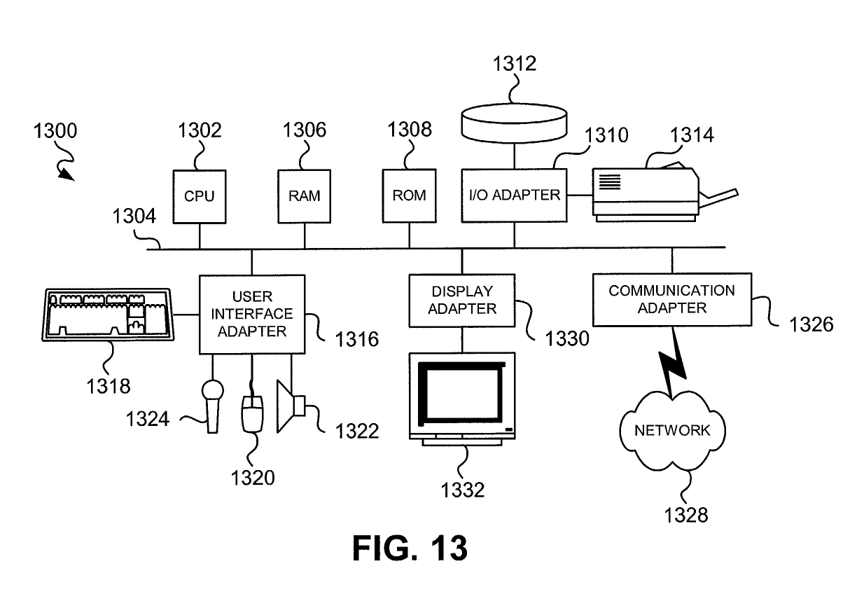

A representative hardware environment associated with the various components of FIG. 12 is depicted in FIG. 13. In the present description, the various sub-components of each of the components may also be considered components of the system. For example, particular software modules executed on any component of the system may also be considered components of the system. FIG. 13 illustrates an illustrative hardware configuration of a workstation 1300 having a central processing unit 1302, such as a microprocessor, and a number of other units interconnected via a system bus 1304.

The workstation shown in FIG. 13 includes a Random Access Memory (RAM) 1306, Read Only Memory (ROM) 1308, an I/O adapter 1310 for connecting peripheral devices such as, for example, disk storage units 1312 and printers 1314 to the bus 1304, a user interface adapter 1316 for connecting various user interface devices such as, for example, a keyboard 1318, a mouse 1320, a speaker 1322, a microphone 1324, and/or other user interface devices such as a touch screen or a digital camera to the bus 1304, a communication adapter 1326 for connecting the workstation 1300 to a communication network 1328 (e.g., a data processing network) and a display adapter 1330 for connecting the bus 1304 to a display device 1332. The workstation may utilize an operating system such as the Microsoft Windows NT or Windows/95 Operating System (OS), the IBM OS/2 operating system, the MAC OS, or UNIX operating system. Those skilled in the art will appreciate that the present invention may also be implemented on platforms and operating systems other than those mentioned.

An embodiment of the present invention may also be written using Java, C, and the C++ language and utilize object oriented programming methodology. Object oriented programming (OOP) has become increasingly used to develop complex applications. As OOP moves toward the mainstream of software design and development, various software solutions require adaptation to make use of the benefits of OOP. A need exists for these principles of OOP to be applied to a messaging interface of an electronic messaging system such that a set of OOP classes and objects for the messaging interface can be provided.

OOP is a process of developing computer software using objects, including the steps of analyzing the problem, designing the system, and constructing the program. An object is a software package that contains both data and a collection of related structures and procedures. Since it contains both data and a collection of structures and procedures, it can be visualized as a self-sufficient component that does not require other additional structures, procedures or data to perform its specific task. OOP, therefore, views a computer program as a collection of largely autonomous components, called objects, each of which is responsible for a specific task. This concept of packaging data, structures, and procedures together in one component or module is called encapsulation.

In general, OOP components are reusable software modules which present an interface that conforms to an object model and which are accessed at run-time through a component integration architecture. A component integration architecture is a set of architecture mechanisms which allow software modules in different process spaces to utilize each others capabilities or functions. This is generally done by assuming a common component object model on which to build the architecture. It is worthwhile to differentiate between an object and a class of objects at this point. An object is a single instance of the class of objects, which is often just called a class. A class of objects can be viewed as a blueprint, from which many objects can be formed.

OOP allows the programmer to create an object that is a part of another object. For example, the object representing a piston engine is said to have a composition-relationship with the object representing a piston. In reality, a piston engine comprises a piston, valves and many other components; the fact that a piston is an element of a piston engine can be logically and semantically represented in OOP by two objects.

OOP also allows creation of an object that “depends from” another object. If there are two objects, one representing a piston engine and the other representing a piston engine wherein the piston is made of ceramic, then the relationship between the two objects is not that of composition. A ceramic piston engine does not make up a piston engine. Rather it is merely one kind of piston engine that has one more limitation than the piston engine; its piston is made of ceramic. In this case, the object representing the ceramic piston engine is called a derived object, and it inherits all of the aspects of the object representing the piston engine and adds further limitation or detail to it. The object representing the ceramic piston engine “depends from” the object representing the piston engine. The relationship between these objects is called inheritance.

When the object or class representing the ceramic piston engine inherits all of the aspects of the objects representing the piston engine, it inherits the thermal characteristics of a standard piston defined in the piston engine class. However, the ceramic piston engine object overrides these ceramic specific thermal characteristics, which are typically different from those associated with a metal piston. It skips over the original and uses new functions related to ceramic pistons. Different kinds of piston engines have different characteristics, but may have the same underlying functions associated with it (e.g., how many pistons in the engine, ignition sequences, lubrication, etc.). To access each of these functions in any piston engine object, a programmer would call the same functions with the same names, but each type of piston engine may have different/overriding implementations of functions behind the same name. This ability to hide different implementations of a function behind the same name is called polymorphism and it greatly simplifies communication among objects.

With the concepts of composition-relationship, encapsulation, inheritance and polymorphism, an object can represent just about anything in the real world. In fact, one's logical perception of the reality is the only limit on determining the kinds of things that can become objects in object-oriented software. Some typical categories are as follows:

Objects can represent physical objects, such as automobiles in a traffic-flow simulation, electrical components in a circuit-design program, countries in an economics model, or aircraft in an air-traffic-control system.

Objects can represent elements of the computer-user environment such as windows, menus or graphics objects.

An object can represent an inventory, such as a personnel file or a table of the latitudes and longitudes of cities.

An object can represent user-defined data types such as time, angles, and complex numbers, or points on the plane.

With this enormous capability of an object to represent just about any logically separable matters, OOP allows the software developer to design and implement a computer program that is a model of some aspects of reality, whether that reality is a physical entity, a process, a system, or a composition of matter. Since the object can represent anything, the software developer can create an object which can be used as a component in a larger software project in the future.

If 90% of a new OOP software program consists of proven, existing components made from preexisting reusable objects, then only the remaining 10% of the new software project has to be written and tested from scratch. Since 90% already came from an inventory of extensively tested reusable objects, the potential domain from which an error could originate is 10% of the program. As a result, OOP enables software developers to build objects out of other, previously built objects.

This process closely resembles complex machinery being built out of assemblies and sub-assemblies. OOP technology, therefore, makes software engineering more like hardware engineering in that software is built from existing components, which are available to the developer as objects. All this adds up to an improved quality of the software as well as an increased speed of its development.

Programming languages are beginning to fully support the OOP principles, such as encapsulation, inheritance, polymorphism, and composition-relationship. With the advent of the C++ language, many commercial software developers have embraced OOP. C++ is an OOP language that offers a fast, machine-executable code. Furthermore, C++ is suitable for both commercial-application and systems-programming projects. For now, C++ appears to be the most popular choice among many OOP programmers, but there is a host of other OOP languages, such as Smalltalk, Common Lisp Object System (CLOS), and Eiffel. Additionally, OOP capabilities are being added to more traditional popular computer programming languages such as Pascal.

The benefits of object classes can be summarized, as follows:

Objects and their corresponding classes break down complex programming problems into many smaller, simpler problems.

Encapsulation enforces data abstraction through the organization of data into small, independent objects that can communicate with each other. Encapsulation protects the data in an object from accidental damage, but allows other objects to interact with that data by calling the object's member functions and structures.

Subdlassing and inheritance make it possible to extend and modify objects through deriving new kinds of objects from the standard classes available in the system. Thus, new capabilities are created without having to start from scratch.

Polymorphism and multiple inheritance make it possible for different programmers to mix and match characteristics of many different classes and create specialized objects that can still work with related objects in predictable ways.

Class hierarchies and containment hierarchies provide a flexible mechanism for modeling real-world objects and the relationships among them.

Libraries of reusable classes are useful in many situations, but they also have some limitations. For example:

Complexity. In a complex system, the class hierarchies for related classes can become extremely confusing, with many dozens or even hundreds of classes.

Flow of control. A program written with the aid of class libraries is still responsible for the flow of control (i.e., it must control the interactions among all the objects created from a particular library). The programmer has to decide which functions to call at what times for which kinds of objects.

Duplication of effort. Although class libraries allow programmers to use and reuse many small pieces of code, each programmer puts those pieces together in a different way. Two different programmers can use the same set of class libraries to write two programs that do exactly the same thing but whose internal structure (i.e., design) may be quite different, depending on hundreds of small decisions each programmer makes along the way. Inevitably, similar pieces of code end up doing similar things in slightly different ways and do not work as well together as they should.

Class libraries are very flexible. As programs grow more complex, more programmers are forced to reinvent basic solutions to basic problems over and over again. A relatively new extension of the class library concept is to have a framework of class libraries. This framework is more complex and consists of significant collections of collaborating classes that capture both the small scale patterns and major mechanisms that implement the common requirements and design in a specific application domain. They were first developed to free application programmers from the chores involved in displaying menus, windows, dialog boxes, and other standard user interface elements for personal computers.

Frameworks also represent a change in the way programmers think about the interaction between the code they write and code written by others. In the early days of procedural programming, the programmer called libraries provided by the operating system to perform certain tasks, but basically the program executed down the page from start to finish, and the programmer was solely responsible for the flow of control. This was appropriate for printing out paychecks, calculating a mathematical table, or solving other problems with a program that executed in just one way.

The development of graphical user interfaces began to turn this procedural programming arrangement inside out. These interfaces allow the user, rather than program logic, to drive the program and decide when certain actions should be performed. Today, most personal computer software accomplishes this by means of an event loop which monitors the mouse, keyboard, and other sources of external events and calls the appropriate parts of the programmer's code according to actions that the user performs. The programmer no longer determines the order in which events occur. Instead, a program is divided into separate pieces that are called at unpredictable times and in an unpredictable order. By relinquishing control in this way to users, the developer creates a program that is much easier to use. Nevertheless, individual pieces of the program written by the developer still call libraries provided by the operating system to accomplish certain tasks, and the programmer must still determine the flow of control within each piece after it's called by the event loop. Application code still “sits on top of” the system.

Even event loop programs require programmers to write a lot of code that should not need to be written separately for every application. The concept of an application framework carries the event loop concept further. Instead of dealing with all the nuts and bolts of constructing basic menus, windows, and dialog boxes and then making these things all work together, programmers using application frameworks start with working application code and basic user interface elements in place. Subsequently, they build from there by replacing some of the generic capabilities of the framework with the specific capabilities of the intended application.

Application frameworks reduce the total amount of code that a programmer has to write from scratch. However, because the framework is really a generic application that displays windows, supports copy and paste, and so on, the programmer can also relinquish control to a greater degree than event loop programs permit. The framework code takes care of almost all event handling and flow of control, and the programmer's code is called only when the framework needs it (e.g., to create or manipulate a proprietary data structure).

A programmer writing a framework program not only relinquishes control to the user (as is also true for event loop programs), but also relinquishes the detailed flow of control within the program to the framework. This approach allows the creation of more complex systems that work together in interesting ways, as opposed to isolated programs, having custom code, being created over and over again for similar problems.

Thus, as is explained above, a framework basically is a collection of cooperating classes that make up a reusable design solution for a given problem domain. It typically includes objects that provide default behavior (e.g., for menus and windows), and programmers use it by inheriting some of that default behavior and overriding other behavior so that the framework calls application code at the appropriate times.

There are three main differences between frameworks and class libraries:

Behavior versus protocol. Class libraries are essentially collections of behaviors that you can call when you want those individual behaviors in your program. A framework, on the other hand, provides not only behavior but also the protocol or set of rules that govern the ways in which behaviors can be combined, including rules for what a programmer is supposed to provide versus what the framework provides.

Call versus override. With a class library, the code the programmer instantiates objects and calls their member functions. It's possible to instantiate and call objects in the same way with a framework (i.e., to treat the framework as a class library), but to take full advantage of a framework's reusable design, a programmer typically writes code that overrides and is called by the framework. The framework manages the flow of control among its objects. Writing a program involves dividing responsibilities among the various pieces of software that are called by the framework rather than specifying how the different pieces should work together.

Implementation versus design. With class libraries, programmers reuse only implementations, whereas with frameworks, they reuse design. A framework embodies the way a family of related programs or pieces of software work. It represents a generic design solution that can be adapted to a variety of specific problems in a given domain. For example, a single framework can embody the way a user interface works, even though two different user interfaces created with the same framework might solve quite different interface problems.

Thus, through the development of frameworks for solutions to various problems and programming tasks, significant reductions in the design and development effort for software can be achieved. An embodiment of the invention utilizes HyperText Markup Language (HTML) to implement documents on the Internet together with a general-purpose secure communication protocol for a transport medium between the client and the server. HTTP or other protocols could be readily substituted for HTML without undue experimentation. Information on these products is available in T. Berners-Lee, D. Connoly, “RFC 1866: Hypertext Markup Language—2.0” (Nov. 1995); and R. Fielding, H, Frystyk, T. Berners—Lee, J. Gettys and J. C. Mogul, “Hypertext Transfer Protocol—HTTP/1.1: HTTP Working Group Internet Draft” (May 2, 1996). HTML is a simple data format used to create hypertext documents that are portable from one platform to another. HTML documents are SGML documents with generic semantics that are appropriate for representing information from a wide range of domains. HTML has been in use by the World-Wide Web global information initiative since 1990. HTML is an application of ISO Standard 8879; 1986 Information Processing Text and Office Systems; Standard Generalized Markup Language (SGML).

To date, Web development tools have been limited in their ability to create dynamic Web applications which span from client to server and interoperate with existing computing resources. Until recently, HTML has been the dominant technology used in development of Web-based solutions. However, HTML has proven to be inadequate in the following areas:

Poor performance;

Restricted user interface capabilities;

Can only produce static Web pages;

Lack of interoperability with existing applications and data; and

Inability to scale.

Sun Microsystems's Java language solves many of the client-side problems by:

Improving performance on the client side;

Enabling the creation of dynamic, real-time Web applications; and

Providing the ability to create a wide variety of user interface components.

With Java, developers can create robust User Interface (UI) components. Custom “widgets” (e.g., real-time stock tickers, animated icons, etc.) can be created, and client-side performance is improved. Unlike HTML, Java supports the notion of client-side validation, offloading appropriate processing onto the client for improved performance. Dynamic, real-time Web pages can be created. Using the above-mentioned custom UI components, dynamic Web pages can also be created.

Sun's Java language has emerged as an industry-recognized language for “programming the Internet.” Sun defines Java as: “a simple, object-oriented, distributed, interpreted, robust, secure, architecture-neutral, portable, high-performance, multithreaded, dynamic, buzzword-compliant, general-purpose programming language. Java supports programming for the Internet in the form of platform-independent Java applets.” Java applets are small, specialized applications that comply with Sun's Java Application Programming Interface (API) allowing developers to add “interactive content” to Web documents (e.g., simple animations, page adornments, basic games, etc.). Applets execute within a Java-compatible browser (e.g., Netscape Navigator) by copying code from the server to client. From a language standpoint, Java's core feature set is based on C++. Sun's Java literature states that Java is basically, “C++ with extensions from Objective C for more dynamic method resolution.”

Another technology that provides similar function to Java is provided by Microsoft and ActiveX Technologies, to give developers and Web designers wherewithal to build dynamic content for the Internet and personal computers. ActiveX includes tools for developing animation, 3-D virtual reality, video and other multimedia content. The tools use Internet standards, work on multiple platforms, and are being supported by over 100 companies. The group's building blocks are called ActiveX Controls, small, fast components that enable developers to embed parts of software in hypertext markup language (HTML) pages. ActiveX Controls work with a variety of programming languages including Microsoft Visual C++, Borland Delphi, Microsoft Visual Basic programming system and, in the future, Microsoft's development tool for Java, code named “Jakarta.” ActiveX Technologies also includes ActiveX Server Framework, allowing developers to create server applications. One of ordinary skill in the art readily recognizes that ActiveX could be substituted for Java without undue experimentation to practice the invention.

Transmission Control Protocol/Internet Protocol (TCP/IP) is a basic communication language or protocol of the Internet. It can also be used as a communications protocol in the private networks called intranet and in extranet. When you are set up with direct access to the Internet, your computer is provided with a copy of the TCP/IP program just as every other computer that you may send messages to or get information from also has a copy of TCP/IP.

TCP/IP is a two-layering program. The higher layer, Transmission Control Protocol (TCP), manages the assembling of a message or file into smaller packet that are transmitted over the Internet and received by a TCP layer that reassembles the packets into the original message. The lower layer, Internet Protocol (IP), handles the address part of each packet so that it gets to the right destination. Each gateway computer on the network checks this address to see where to forward the message. Even though some packets from the same message are routed differently than others, they'll be reassembled at the destination.

TCP/IP uses a client/server model of communication in which a computer user (a client) requests and is provided a service (such as sending a Web page) by another computer (a server) in the network. TCP/IP communication is primarily point-to-point, meaning each communication is from one point (or host computer) in the network to another point or host computer. TCP/IP and the higher-level applications that use it are collectively said to be “stateless” because each client request is considered a new request unrelated to any previous one (unlike ordinary phone conversations that require a dedicated connection for the call duration). Being stateless frees network paths so that everyone can use them continuously. (Note that the TCP layer itself is not stateless as far as any one message is concerned. Its connection remains in place until all packets in a message have been received.).

Many Internet users are familiar with the even higher layer application protocols that use TCP/IP to get to the Internet. These include the World Wide Web's Hypertext Transfer Protocol (HTTP), the File Transfer Protocol (FTP), Telnet which lets you logon to remote computers, and the Simple Mail Transfer Protocol (SMTP). These and other protocols are often packaged together with TCP/IP as a “suite.”Personal computer users usually get to the Internet through the Serial Line Internet Protocol (SLIP) or the Point-to-Point Protocol. These protocols encapsulate the IP packets so that they can be sent over a dial-up phone connection to an access provider's modem.

Protocols related to TCP/IP include the User Datagram Protocol (UDP), which is used instead of TCP for special purposes. Other protocols are used by network host computers for exchanging router information. These include the Internet Control Message Protocol (ICMP), the Interior Gateway Protocol (IGP), the Exterior Gateway Protocol (EGP), and the Border Gateway Protocol (BGP).

Internetwork Packet Exchange (IPX)is a networking protocol from Novell that interconnects networks that use Novell's NetWare clients and servers. IPX is a datagram or packet protocol. IPX works at the network layer of communication protocols and is connectionless (that is, it doesn't require that a connection be maintained during an exchange of packets as, for example, a regular voice phone call does).

Packet acknowledgment is managed by another Novell protocol, the Sequenced Packet Exchange (SPX). Other related Novell NetWare protocols are: the Routing Information Protocol (RIP), the Service Advertising Protocol (SAP), and the NetWare Link Services Protocol (NLSP).

A virtual private network (VPN) is a private data network that makes use of the public telecommunication infrastructure, maintaining privacy through the use of a tunneling protocol and security procedures. A virtual private network can be contrasted with a system of owned or leased lines that can only be used by one company. The idea of the VPN is to give the company the same capabilities at much lower cost by using the shared public infrastructure rather than a private one. Phone companies have provided secure shared resources for voice messages. A virtual private network makes it possible to have the same secure sharing of public resources for data.

Using a virtual private network involves encryption data before sending it through the public network and decrypting it at the receiving end. An additional level of security involves encrypting not only the data but also the originating and receiving network addresses. Microsoft, 3Com, and several other companies have developed the Point-to-Point Tunneling Protocol (PPP) and Microsoft has extended Windows NT to support it. VPN software is typically installed as part of a company's firewall server.

Wireless refers to a communications, monitoring, or control system in which electromagnetic radiation spectrum or acoustic waves carry a signal through atmospheric space rather than along a wire. In most wireless systems, radio frequency (RF) or infrared transmission (IR) waves are used. Some monitoring devices, such as intrusion alarms, employ acoustic waves at frequencies above the range of human hearing.

Early experimenters in electromagnetic physics dreamed of building a so-called wireless telegraph. The first wireless telegraph transmitters went on the air in the early years of the 20th century. Later, as amplitude modulation (AM) made it possible to transmit voices and music via wireless, the medium came to be called radio. With the advent of television, fax, data communication, and the effective use of a larger portion of the electromagnetic spectrum, the original term has been brought to life again.

Common examples of wireless equipment in use today include the Global Positioning System, cellular telephone phones and pagers, cordless computer accessories (for example, the cordless mouse), home-entertainrent-system control boxes, remote garage-door openers, two-way radios, and baby monitors. An increasing number of companies and organizations are using wireless LAN. Wireless transceivers are available for connection to portable and notebook computers, allowing Internet access in selected cities without the need to locate a telephone jack. Eventually, it will be possible to link any computer to the Internet via satellite, no matter where in the world the computer might be located.

Bluetooth is a computing and telecommunications industry specification that describes how mobile phones, computers, and personal digital assistants (PDA's) can easily interconnect with each other and with home and business phones and computers using a short-range wireless connection. Each device is equipped with a microchip transceiver that transmits and receives in a previously unused frequency band of 2.45 GHz that is available globally (with some variation of bandwidth in different countries). In addition to data, up to three voice channels are available. Each device has a unique 48-bit address from the IEEE 802 standard. Connections can be point-to-point or multipoint. The maximum range is 10 meters. Data can be presently be exchanged at a rate of 1 megabit per second (up to 2 Mbps in the second generation of the technology). A frequency hop scheme allows devices to communicate even in areas with a great deal of electromagnetic interference. Built-in encryption and verification is provided.

Encryption is the conversion of data into a form, called a ciphertext, that cannot be easily understood by unauthorized people. Decryption is the process of converting encrypted data back into its original form, so it can be understood.

The use of encryption/decryption is as old as the art of communication. In wartime, a cipher, often incorrectly called a “code,” can be employed to keep the enemy from obtaining the contents of transmissions (technically, a code is a means of representing a signal without the intent of keeping it secret; examples are Morse code and ASCII.). Simple ciphers include the substitution of letters for numbers, the rotation of letters in the alphabet, and the “scrambling” of voice signals by inverting the sideband frequencies. More complex ciphers work according to sophisticated computer algorithm that rearrange the data bits in digital signals.

In order to easily recover the contents of an encrypted signal, the correct decryption key is required. The key is an algorithm that “undoes” the work of the encryption algorithm.

Alternatively, a computer can be used in an attempt to “break” the cipher. The more complex the encryption algorithm, the more difficult it becomes to eavesdrop on the communications without access to the key.

Rivest-Shamir-Adleman (RSA) is an Internet encryption and authentication system that uses an algorithm developed in 1977 by Ron Rivest, Adi Shamir, and Leonard Adleman. The RSA algorithm is a commonly used encryption and authentication algorithm and is included as part of the Web browser from Netscape and Microsoft. It's also part of Lotus Notes, Intuit's Quicken, and many other products. The encryption system is owned by RSA Security.

The RSA algorithm involves multiplying two large prime numbers (a prime number is a number divisible only by that number and 1) and through additional operations deriving a set of two numbers that constitutes the public key and another set that is the private key. Once the keys have been developed, the original prime numbers are no longer important and can be discarded. Both the public and the private keys are needed for encryption/decryption but only the owner of a private key ever needs to know it. Using the RSA system, the private key never needs to be sent across the Internet.

The private key is used to decrypt text that has been encrypted with the public key. Thus, if I send you a message, I can find out your public key (but not your private key) from a central administrator and encrypt a message to you using your public key. When you receive it, you decrypt it with your private key. In addition to encrypting messages (which ensures privacy), you can authenticate yourself to me (so I know that it is really you who sent the message) by using your private key to encrypt a digital certificate. When I receive it, I can use your public key to decrypt it.

While various embodiments have been described above, it should be understood that they have been presented by way of example only, and not limitation. Thus, the breadth and scope of a preferred embodiment should not be limited by any of the above described exemplary embodiments, but should be defined only in accordance with the following claims and their equivalents.

Based on the foregoing specification, the invention may be implemented using computer programming or engineering techniques including computer software, firmware, hardware or any combination or subset thereof. Any such resulting program, having computer-readable code means, may be embodied or provided within one or more computer-readable media, thereby making a computer program product, i.e., an article of manufacture, according to the invention. The computer readable media may be, for instance, a fixed (hard) drive, diskette, optical disk, magnetic tape, semiconductor memory such as read-only memory (ROM), etc., or any transmitting/receiving medium such as the Internet or other communication network or link. The article of manufacture containing the computer code may be made and/or used by executing the code directly from one medium, by copying the code from one medium to another medium, or by transmitting the code over a network.

One skilled in the art of computer science will easily be able to combine the software created as described with appropriate general purpose or special purpose computer hardware to create a computer system or computer sub-system embodying the method of the invention.

While various embodiments have been described above, it should be understood that they have been presented by way of example only, and not limitation. Thus, the breadth and scope of a preferred embodiment should not be limited by any of the above described exemplary embodiments, but should be defined only in accordance with the following claims and their equivalents.

APPENDIX A
<?xml version=“1.0” encoding=“UTF-8”?>
<!--<?xml-stylesheet type=“text/xsl” href=“style1.xsl”?>-->
<!--<!DOCTYPE worksheet SYSTEM “Untitled2.dtd”>-->
<worksheet id=“w001”>

<section id=“s001”>

<title>First Section</title>
<description>This section prompts for at least 3 clinical elements. Please select one

observation, then at least two from problem, medOrder or reminder:</description>

<cec id=“c001” type=“observation” sel=“no”>

<label tgt=“description”>Blood pressure (mmHg sbp/dbp):</label>
<m id=“m002” type=“textbox” size=“5” tgt=“description”>100</m>
<label tgt=“description”>/</label>
<m id=“m004” type=“textbox” size=“5” tgt=“description”>80</m>
<code id=“cd001” type=“VHSI/PEX/VS”>SBP</code>
<code id=“cd002” type=“VHSI/PEX/VS”>DBP</code>
<msg id=“cm002” type=“redo” display=“no”>SBP must be a number between

the DBP and 300</msg>

<msg id=“cm001” type=“redo” display=“no”>DBP must be a number between

50 and 200</msg>

</cec>
<cec id=“c002” type=“problem” sel=“no”>

<label tgt=“description”>Hypertension, essential</label>
<code id=“cd003” type=“ICD9-CM”>401.9</code>

</cec>
<cec id=“c003” type=“medOrder” sel=“no”>

<label tgt=“medBrand”>Tenormin</label>
<label tgt=“medName”>atenolol</label>
<label tgt=“strForm”>50 mg tabs</label>
<m id=“m009” type=“textarea” rows=“2” cols=“30” tgt=“sig”>Take as

directed.</m>

<m id=“m010” type=“textbox” size=“2” tgt=“quantity”>100</m>
<m id=“m011” type=“pulldown” size=“1” tgt=“numRefills”>

<option>1</option>
<option>2</option>
<option>3</option>
<option default=“yes”>No refills</option>

</m>
<m id=“m012” type=“checkbox” tgt=“subGeneric”>Do Not Substitute</m>
<code id=“cd004” type=“MEDISPAN/GPI”>660345892</code>
<msg id=“cm004” type=“redo” display=“no”>Quantity must be between 1 and

1000</msg>

</cec>
<cec id=“c004” type=“reminder” sel=“no”>

<label>RTC 2-4 weeks</label>
<hidden tgt=“startDT”>Today+2 weeks</hidden>
<hidden tgt=“endDT”>Today+4 weeks</hidden>
<hidden tgt=“msgText”>Patient overdue for clinic appointment.</hidden>

</cec>
<msg id=“sm001” type=“redo” display=“no”>Must select one observation, then at least

two from problem, medOrder or reminder!</msg>

</section>
<section id=“s003”>

<title>Age/Gender/Ethnicity</title>
<description>This section prompts for birthdate, gender,
and ethnicity, per the US Census 2000 guidelines. It then generates a characterization
string like ‘47 YO WM’</description>
<cec id=“c009” type=“observation” sel=“implicit”>

<label>Date of Birth (MM//DD/YYYY): </label>
<m id=“m018” type=“textbox” size=“10” tgt=“DOB”>11/11/1111</m>
<msg id=“cm006” type=“redo” display=“no”>DOB must be of the form

mm/dd/yyyy</msg>

<msg id=“cm006a” type=“redo” display=“no”>The month must be between 01

(January) and 12 (December)</msg>

<msg id=“cm006b” type=“redo” display=“no”>The day must be a valid date for

the month specified</msg>

<msg id=“cm007” type=“redo” display=“no”>DOB must NOT be in the

future.</msg>

</cec>
<cec id=“c010” type=“observation” sel=“implicit”>

<label>Gender:</label>
<m id“m020” type=“radioButton” orient=“vertical” tgt=“Gender”>

<option>female</option>
<option>male</option>
<option default=“yes”>unknown</option>

</m>

</cec>
<cec id=“c011” type=“observation” sel=“implicit”>

<label>Ethnicity: </label>
<m id=“m022” type=“radioButton” orient=“vertical” tgt=“Ethnicity1”>

<option id=“o022a” default=“yes”>unknown</option>
<option id=“o022b”>other, decline to state</option>
<option id=“o022c”>per US Census (see below)</option>

</m>
<section id=“s004”>

<title>US Census ethnicity determination</title>
<description>US Census ethnicity matrix</description>
<cec id=“c111” type=“observation” sel=“implicit”>

<label>Check one: </label>
<m id=“m024” type=“radioButton” orient=“vertical”

tgt=“Ethnicity2”>

<option id=“o024a”>Hispanic or Latino</option>
<option id=“o024b”>NOT Hispanic or

Latino</option>

</m>
<msg id=“cm008” type=“redo” display=“no”>Having chosen

‘US Census’ option for ethnicity, you MUST select one of

‘Hispanic or Latino’ or ‘NOT Hispanic or Latino.’</msg>

</cec>
<cec id=“c012” type=“observation” sel=“implicit”>

<label>Then check all that apply: </label>
<m id=“m026” type=“checkbox”

tgt=“Ethnicity3 ”>White</m>

<m id=“m027” type=“checkbox” tgt=“Ethnicity3 ”>Black or

African American</m>

<m id=“m028” type=“checkbox” tgt=“Ethnicity3 ”>Asian,

specifically </m>

<m idref=“m028” type=“textbox” size=“20”

tgt=“Ethnicity3”/>

<m id=“m030” type=“checkbox” tgt=“Ethnicity3”>Native

Hawaiian or Other Pacific Islander, specifically</m>

<m idref=“m030” type=“textbox” size=“20”

tgt=“Ethnicity3 ”/>

<m id“m032” type=“checkbox” tgt=“Ethnicity3”>American

Indian or Alaska Native, enrolled or principal tribe</m>

<m idref=“m032” type=“textbox” size=“20”

tgt=“Ethnicity3 ”/>

<m id=“m034” type=“checkbox” tgt=“Ethnicity3”>Other,

specifically</m>

<m idref=“m034” type=“textbox” size=“20”

tgt=“Ethnicity3 ”/>

<msg id=“cm009” type=“redo” display=“no”>Having chosen

‘US Census’ option for ethnicity, you MUST select at least one of ‘White’, ‘Black or African American’,
etc!</msg>

</cec>

</section>
<section id=“s0O2”>

<title>Second Section</title>
<description>Here's another embedded section (elements are

blank)</description>

<cec id=“c005” type=“observation” sel=“no”/>
<cec id=“c006” type=“problem” sel=“no”/>
<cec id=“c007” type=“medOrder” sel=“no”/>
<cec id=“c008” type=“reminder” sel=“no”/>
<msg id=“sm002” type=“redo” display=“no”>Must select one

observation, one problem, then at most one from problem, medOrder or reminder!</msg>

</section>

</cec>
<cec id=“c205” type=“observation” sel=“no”>

<label>This is a label.</label>

</cec>
<msg id=“sm004” display=“no”>Must enter date of birth, gender AND ethnicity to

compute characterization string!</msg>

</section>
<section id=“s005”>

<title>Second Section</title>
<description>This section likewise prompts for four clinical elements. Here, however,
please select one observation, one problem, then at most one from problem,
medOrder or reminder: (elements are blank, no validation)</description>
<cec id=“c105” type=“observation” sel=“no”/>
<cec id=“c106” type=“problem” sel“no”/>
<cec id=“c107” type=“medOrder” sel=“no”/>
<cec id=“c108” type=“reminder” sel=“no”/>

</section>

</worksheet>

What is claimed is:

1. A method for collecting information, comprising:
a) displaying information based on at least a portion of a plurality of record element constructors of a template to a user;
b) receiving input for the record element constructors from the user in response to the displayed information;
c) determining whether the received input is valid for the record element constructors;
d) generating record elements based on the record element constructors and the received input; and
e) storing the record elements in a database.

2. The method of claim 1, wherein the template is in an extensible markup language (XML) format.

3. The method of claim 1, wherein one or more extensible style sheet language (XSL) style sheets are utilized during execution of elements a, c and d.

4. The method of claim 1, wherein template is divided into a plurality of sections each having a plurality of record element constructors, and wherein elements a, b, c and d are repeated for each section of the template.

5. The method of claim 1, wherein an extensible style sheet language (XSL) style sheet is applied to at least a portion of the record element constructors to generate the information displayed to the user.

6. The method of claim 1, wherein the record elements are utilized in providing health care to the user.

7. The method of claim 1, wherein an alert is displayed to the user if at least a portion of the input is determined to be invalid for the record element constructors.

8. The method of claim 7, wherein the user is required to provide additional input unit for the portion of the input determined to be invalid.

9. The method of claim 1, wherein the information is displayed to the user in an hypertext markup language (HTML) format.

10. The method of claim 1, wherein the information is displayed to the user utilizing a network.

11. The method of claim 1, wherein the stored record elements are retrieved by and displayed to at least one of the user and a third party.

12. The method of claim 1, further comprising receiving a request for a service associated with the user, retrieving stored record elements from the database associated with the user, and issuing an order based on the request and the retrieved record elements.

13. A system for collecting information, comprising:
a) logic for displaying information based on at least a portion of a plurality of record element constructors of a template to a user;
b) logic for receiving input for the record element constructors from the user in response to the displayed information;
c) logic for determining whether the received input is valid for the record element constructors;
d) logic for generating record elements based on the record element constructors and the received input; and
e) logic for storing the record elements in a database.

14. The system of claim 13, wherein the template is in an extensible markup language (XML) format.

15. The system of claim 13, wherein an alert is displayed to the user if at least a portion of the input is determined to be invalid for the record element constructors.

16. The system of claim 13, wherein the information is displayed to the user utilizing a network.

17. A computer program product for collecting information, comprising:
a) computer code for displaying information based on at least a portion of a plurality of record element constructors of a template to a user;
b) computer code for receiving input for the record element constructors from the user in response to the displayed information;
c) computer code for determining whether the received input is valid for the record element constructors;
d) computer code for generating record elements based on the record element constructors and the received input; and
e) computer code for storing the record elements in a database.

18. The computer program product of claim 17, wherein the template is in an extensible markup language (XML) format.

19. The computer program product of claim 17, wherein an alert is displayed to the user if at least a portion of the input is determined to be invalid for the record element constructors.

20. The computer program product of claim 17, wherein the information is displayed to the user utilizing a network.

21. A method for utilizing a worksheet template to collect information, the worksheet template having an extensible markup language (XML) format and comprising one or more sections, and each section comprising a set of record element constructors, the method comprising:
applying a set of style sheets in sequence to each section of the worksheet template to: generate a display based on the set of record element constructors of the particular section of the worksheet template; display the generated display to a user; receive input from the user based on the display; determine whether the received input is valid for all of the record element constructors of the particular section; and generate record elements based on the record element constructors of the section and the received input; and
storing the generated record elements of all of the sections of the worksheet template in a database as a transaction.
